(19) United States
(12) Patent Application Publication
(10) Pub. No.: US 2025/0307929 A1
(43) Pub. Date: Oct. 2, 2025

(54) BLOCKCHAIN WALLET-BASED 24-HOUR CURRENCY EXCHANGE SERVICE METHOD

(71) Applicant: SWITCHWON CO., LTD., Busan (KR)

(72) Inventor: Jeong A SEO, Seoul (KR)

(21) Appl. No.: 19/237,625

(22) Filed: Jun. 13, 2025

Related U.S. Application Data
(63) Continuation of application No. PCT/KR2022/020442, filed on Dec. 15, 2022.

(30) Foreign Application Priority Data
Dec. 15, 2022 (KR) 10-2022-0175516

(51) Int. Cl. G06Q 40/04; G06Q 20/10; G06Q 20/36; G06Q 20/38

(52) U.S. Cl. CPC G06Q 40/04; G06Q 20/10; G06Q 20/36; G06Q 20/381; G06Q 2220/00

(57) ABSTRACT

An embodiment relates to a method for providing a 24-hour currency exchange service based on a blockchain wallet, executed by a main server. The method comprises: (a) generating a wallet account linked to a first national currency bank account of a user in response to a request from a user terminal; (b) receiving a currency exchange request from the user terminal and determining an exchange rate; and (c) verifying whether the requested amount of the first national currency has been deposited into the wallet account, and if deposited, recording the corresponding amount of the second national currency in the wallet account and distributing and storing the exchange transaction between the first and second national currencies across a blockchain network.

### CROSS-REFERENCE TO RELATED APPLICATION

This application is a Continuation of International Application No. PCT/KR2022/020442 filled on Dec. 15, 2022, which claims priority to Korean Patent Application No. 10-2022-0175516 filed on Dec. 15, 2022, in the Korean Intellectual Property Office, the disclosure of which is incorporated by reference herein in its entirety.

### BACKGROUND

### Field

The present invention relates to a blockchain wallet-based 24-hour currency exchange service method, and more specifically, to a method and system for providing a 24-hour currency exchange service using a wallet account without direct transactions with a bank server.

Recently, the markets for blockchain and fintech technologies have been experiencing rapid growth, with increasing expectations for the advent of a Web 3.0 era powered by blockchain, replacing the Web 2.0 era once led by global corporations such as Google, Facebook, and Amazon.

Accordingly, the development of financial services such as various banking operations and currency exchange using highly secure blockchain technology is actively underway, and numerous companies are already offering such services.

In particular, for currency exchange services, blockchain technology can help address issues such as traffic costs and security vulnerabilities that arise with each transaction, making the development of relevant technologies increasingly necessary.

### SUMMARY

### Technical Problem

The present invention has been devised to address the aforementioned issues of the prior art, and its objective is to provide a blockchain wallet-based 24-hour currency exchange service.

Another objective is to securely store personal and bank-related information generated during the exchange process using blockchain techniques and to provide exchange services based on the stored information, regardless of time constraints.

The technical problems to be solved by the present invention are not limited to those mentioned above, and other problems not explicitly described will be clearly understood through the following detailed description.

### Technical Solution

To achieve the above technical objectives, one embodiment of the present invention provides a method, performed by a main server, for providing a blockchain wallet-based 24-hour currency exchange service, comprising: (a) creating a wallet account linked to the user's bank account in the first country's currency upon request from a user terminal; (b) receiving a currency exchange request from the user terminal and determining an exchange rate; (c) verifying whether the amount of the first country's currency requested for exchange has been deposited into the wallet account, and if so, recording the corresponding amount of the second country's currency in the wallet account, and distributing the exchange transaction between the first and second country's currencies to a blockchain network. Step (b) may include determining the exchange rate according to a pre-established policy by the main server when the exchange request occurs during non-business hours where the standard rate from a foreign exchange brokerage is not available.

In step (a), the wallet account may be created in a manner that is linked both to a bank account operated by a domestic bank and to an account operated by the main server.

Step (b) may further include: (b-1) receiving the type and amount of the first country's currency to be deposited into the wallet account from the user terminal; (b-2) receiving the type of the second country's currency to be received into the wallet account from the user terminal; and (b-3) determining the exchange rate for converting the first country's currency into the second country's currency based on the main server's policy and the time the exchange request is received.

The exchange rate may be determined based on the standard rate of a foreign exchange brokerage or, during non-business hours, based on the average of the buying and selling rates of the day.

In step (c), after recording the exchange transaction details in the wallet account, the type and amount of the first and second country's currencies, the exchange rate, exchange time, and user terminal identification information may be matched to generate first block data, which may then be distributed and stored across at least one main server and other terminals connected to the main server according to a blockchain technique.

The exchange transaction details may include the exchanged amount of the second country's currency, exchange rate, and exchange time for each transaction, along with profit/loss information calculated by comparing the exchanged amount at the exchange time to that at a preset time before or after the exchange time.

The method may further include: (d) receiving a request from the user terminal to exchange the second country's currency stored in the wallet into the first country's currency; and (e) determining the exchange rate for selling the second country's currency and buying the first country's currency, recording the transaction in the wallet, generating second block data by matching the transaction details, and storing the data on the blockchain.

In steps (c) through (e), no actual withdrawal or deposit transactions may occur between the bank accounts of the first and second country's currencies; rather, only transaction records may be generated in the wallet.

Step (f) may include, upon receiving a withdrawal request for the second country's currency from the user terminal, withdrawing the requested amount from the bank account associated with the main server and transferring it to a user-specified bank account; and upon receiving a withdrawal request for the first country's currency, withdrawing the requested amount from the first country's currency account associated with the main server and transferring it to the bank account linked to the wallet account.

A blockchain wallet-based 24-hour currency exchange service server according to one embodiment of the present invention may include: a memory storing a program for executing the aforementioned method; and a processor for executing the program, where the method includes the above steps (a) through (c), and in step (b), the exchange rate is determined by the main server based on a preset policy if the exchange request occurs outside the foreign exchange brokerage's standard operating hours.

### Advantageous Effects of the Invention

The present invention provides a blockchain wallet-based 24-hour currency exchange service, enabling secure storage of personal and banking information generated during the exchange process using blockchain technology, thereby offering an exchange service with enhanced security.

Furthermore, by storing exchange-related information in a wallet account upon an exchange request and providing services based on the stored information, the invention enables uninterrupted currency exchange regardless of the operational hours of bank servers, which are typically limited to regular business hours.

### BRIEF DESCRIPTION OF THE DRAWINGS

FIG. 1 is a structural diagram of a system for providing a 24-hour currency exchange service based on a blockchain wallet according to an embodiment of the present invention.

FIGS. 2 and 3 are block diagrams showing the internal configuration of a server for providing a 24-hour currency exchange service based on a blockchain wallet according to an embodiment of the present invention.

FIG. 4 is a flowchart illustrating the procedure for providing a 24-hour currency exchange service based on a blockchain wallet according to an embodiment of the present invention.

FIG. 5 is a flowchart of block information generation, storage, and remittance according to an embodiment of the present invention.

### DETAILED DESCRIPTION

The following describes exemplary embodiments of the present invention in detail with reference to the accompanying drawings so that those skilled in the art to which the invention pertains can easily implement it. However, the invention may be embodied in various different forms and is not limited to the embodiments described herein. To clearly illustrate the invention in the drawings, elements not relevant to the description have been omitted, and similar reference numerals are used for similar elements throughout the specification.

In the entire specification, when a part is described as being “connected” to another part, it includes not only cases where they are “directly connected” but also cases where they are “electrically connected” with other elements interposed therebetween. Also, when a part is described as “including” a certain element, it does not exclude other elements unless stated otherwise, and may further include additional elements.

In this specification, the term “unit” refers to a hardware-implemented unit, a software-

implemented unit, or a unit implemented using both hardware and software. One unit may be implemented using two or more pieces of hardware, or two or more units may be implemented using a single piece of hardware. The term “˜unit” is not limited to software or hardware and may be configured on addressable storage media or to execute on one or more processors. For example, a “˜unit” may include software components, object-oriented software components, class components, task components, and also processes, functions, attributes, procedures, subroutines, segments of program code, drivers, firmware, microcode, circuits, data, databases, data structures, tables, arrays, and variables. The functions provided within the components and “˜units” may be combined into fewer components or “˜units” or further divided into additional components or “˜units”. Furthermore, the components and “˜units” may be implemented to execute on one or more CPUs within a device or secure multimedia card.

The “terminal” referred to herein may be implemented as a computer or portable device that can connect to a server or another terminal via a network. The computer may include, for example, a notebook, desktop, laptop, or VR HMD (such as HTC VIVE, Oculus Rift, GearVR, DayDream, PSVR, etc.) equipped with a web browser. VR HMDs include PC-based (e.g., HTC VIVE, Oculus Rift, FOVE, Deepon), mobile-based (e.g., GearVR, DayDream, Baofeng Mojing, Google Cardboard), console-based (e.g., PSVR), and standalone models (e.g., Deepon, PICO). Portable terminals may include wireless communication devices ensuring portability and mobility, such as smartphones, tablet PCs, and wearable devices, and may also include various devices equipped with communication modules such as BLE (Bluetooth Low Energy), NFC, RFID, ultrasonic, infrared, Wi-Fi, or LiFi.

The term “network” refers to a connection structure enabling information exchange between nodes such as terminals and servers, and includes LAN (Local Area Network), WAN (Wide Area Network), Internet (WWW), wired/wireless data communication networks, telephone networks, and television communication networks. Examples of wireless data communication networks include 3G, 4G, 5G, 3GPP, LTE (Long Term Evolution), WIMAX, Wi-Fi, Bluetooth, infrared communication, ultrasonic communication, VLC (Visible Light Communication), and LiFi, but are not limited thereto.

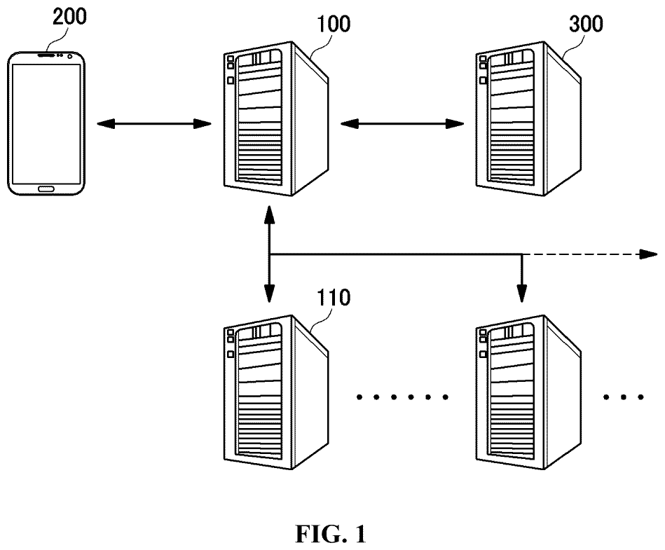

First, referring to FIG. 1, a system for providing a 24-hour currency exchange service based on a blockchain wallet according to an embodiment of the present invention will be described.

According to an embodiment of the present invention, the system may include a main server (100), a user terminal (200), a bank server (300), and a plurality of blockchain servers (110).

The present invention provides a technology in which the main server (100) offers a 24-hour currency exchange service based on a blockchain wallet to the user terminal (200). The main server receives a currency exchange request from the user terminal (200), and stores the personal and banking-related information generated during the exchange process on the blockchain servers (110) using blockchain technology. Based on the stored information, deposits and withdrawals can be performed through the bank server (300), enabling a more secure and time-independent exchange service than conventional methods.

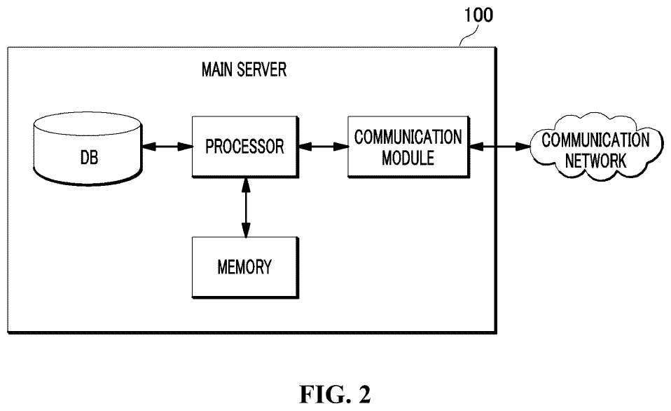

As illustrated in FIG. 2, the main server (100) according to one embodiment of the present

invention may include a memory in which a program (or application) for performing the 24-hour currency exchange service based on a blockchain wallet is stored, and a processor for executing the program. The processor may perform various functions by executing the program stored in the memory.

In addition, the main server (100) may connect to a network through a communication module and communicate wirelessly or via wired connection with the blockchain servers (110), the user terminal (200), and the bank server (300).

The user terminal (200) is a device on which the program or application for performing the blockchain wallet-based 24-hour currency exchange service is installed, and may include a smartphone, laptop, desktop, or tablet PC.

Furthermore, according to an additional embodiment of the present invention, the user terminal (200) may also perform the role of the blockchain server (110) described later.

Next, the blockchain server (110) may be a device having the same structure and functionality as the main server (100). A plurality of blockchain servers (110) may form a blockchain network and perform a distributed storage role by storing multiple block records received from the server.

The bank server (300) may be a server operated domestically in the first country or the second country, providing deposit/withdrawal, account opening, and currency exchange services.

Hereinafter, a method for providing a 24-hour currency exchange service based on a blockchain wallet according to an embodiment of the present invention will be described.

The blockchain wallet-based 24-hour currency exchange service method according to an embodiment of the present invention may be performed by the main server (100).

The main server (100) creates a wallet account linked to a bank account in the first national currency for a user, based on a request from the user terminal (200).

According to one embodiment of the present invention, the user request may be received through a currency exchange UI provided from the main server (100) to the user terminal (200), and the UI may be displayed on the screen by a program or application for performing the blockchain wallet-based 24-hour currency exchange service installed on the user terminal (200).

The wallet account may be generated to link with both a bank account operated by the bank server (300) and an account managed by the main server (100), and may include deposit and withdrawal functions.

The main server (100) receives a currency exchange request from the user terminal (200) and determines the exchange rate for the received request.

In this case, the currency exchange request according to one embodiment of the present invention is received by the user entering the type and amount of the first national currency to be deposited into the wallet account, as well as the type of the second national currency to be received, through the exchange UI of the user terminal (200).

For example, if a user named A wants to exchange KRW 10,000 into USD, the exchange request includes entering “KRW” as the type of first national currency, “10,000” as the amount, and “USD” as the type of second national currency.

Next, the main server (100) determines the exchange rate for purchasing the second national currency with the first national currency, based on the server's policy and the time at which the exchange request was received.

At this point, the exchange rate may be determined according to the standard rate provided by a foreign exchange broker. If the request is made outside of the broker's business hours, the rate may be calculated based on the average of the day's buying and selling prices.

Additionally, even in cases other than non-business hours—such as when the broker's standard rate is unavailable due to issues like server failure—the exchange rate may be determined according to a preset policy established on the main server (100), so that the exchange can still proceed.

In contrast to conventional exchange services provided by bank servers (300), which are unavailable outside of regular operating hours (typically 9 AM to 6 PM), the present invention enables 24-hour exchange services based on wallet account requests. To support this, the system sets the exchange rate during non-operating hours based on the average of the day's buy and sell rates.

Alternatively, the rate may be determined using other methods, such as applying a platform fee surcharge during non-operating hours or setting the rate based on current demand and supply.

Then, the main server (100) checks whether the amount of first national currency requested for exchange has been deposited into the wallet account.

If the deposit has been made, the main server (100) records the equivalent amount of second national currency into the wallet account and distributes the transaction record across the blockchain network.

In one embodiment of the invention, the exchange transaction record includes the exchanged amount of second national currency, the applied exchange rate, and the timestamp of the transaction. It may also include foreign exchange gain/loss information based on comparing the transaction value at the exchange time with values from preset times before or after.

For example, suppose a user named A exchanges KRW 10,000 into USD. If the exchange rate at 1 PM is 1 KRW=0.00076 USD, and the rate at 11 AM is 1 KRW=0.00080 USD, then exchanging at 1 PM results in $7.60. If the user had exchanged at 11 AM, the result would have been $8.00. Therefore, the exchange record may show the actual transaction (7.6 USD at a rate of 0.00076) and include the exchange loss of 0.4 USD.

After the exchange transaction is completed, the record is first stored in the wallet account by the main server (100). Then, the type and amount of the first and second national currencies, the exchange rate, the transaction time, and the user terminal (200) ID are compiled into first block information, which is then distributed across one or more devices including the main server (100) and connected blockchain servers (110), according to blockchain protocols.

According to an additional embodiment of the present invention, to perform distributed storage of exchange transaction records, the main server (100) and the blockchain servers (110) are interconnected via a network, including the internet and Ethernet. In various embodiments, the blockchain servers (110) may be implemented not only as physical hardware-based servers but also as cloud-based servers.

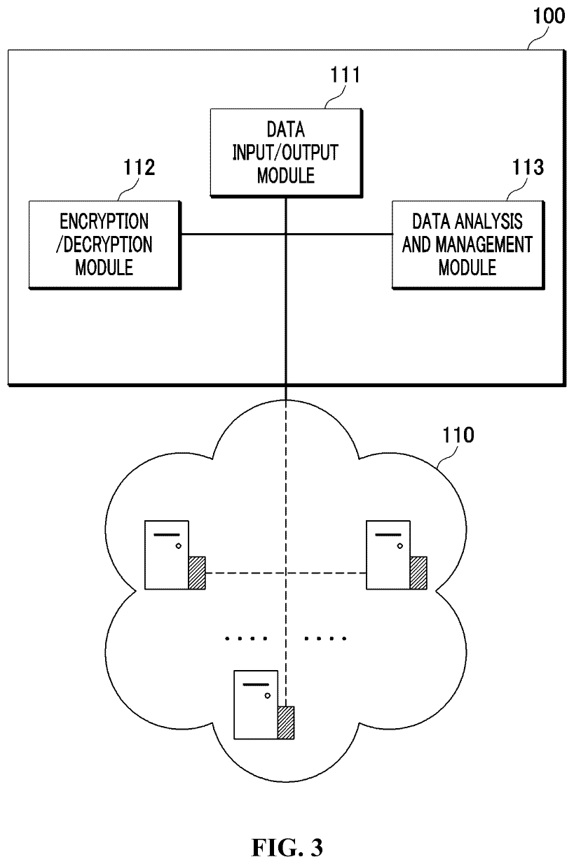

Referring to FIG. 3, in this embodiment, the main server (100) may include: a distributed data storage device for storing exchange transaction records, a data input/output module (111) for inputting exchange transaction records into or retrieving them from the distributed data storage device, an encryption/decryption module (112) for encrypting and decrypting data during input/output operations, and a data analysis and management module (113) for analyzing the storage capacity and location status of the distributed data storage device used in the input/output operations.

Through this configuration, each time an exchange transaction record is input or output via the data input/output module (111), the network of the main server (100) and blockchain servers (110) stores and updates block data across all servers in the network. This block data includes the storage location of the relevant record, the data required for encryption/decryption from the encryption/decryption module (112), and the authorization data for data access.

The data analysis and management module (113) stores identical copies of the exchange transaction record in at least one distributed data storage device across the networked servers. It periodically checks how many of the servers storing the copies are functioning properly and ensures that a preset number of active replicas is maintained.

Aside from this example, other distributed storage methods based on blockchain techniques may be used, but as these fall under the scope of conventional technologies, they are not described in further detail here.

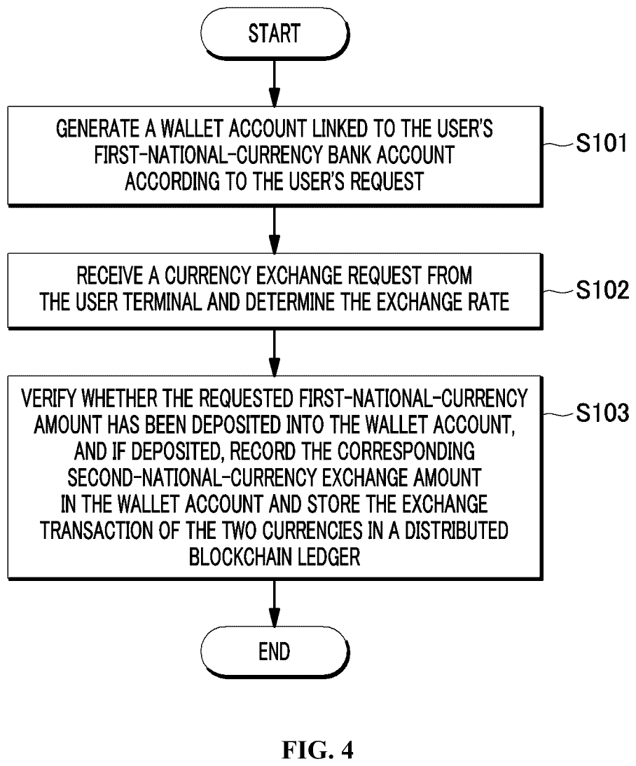

Referring to FIG. 4, the execution sequence of the blockchain wallet-based 24-hour currency exchange service method can be summarized as follows: The main server (100) creates a wallet account linked to the user's first-national-currency bank account upon request from the user terminal (200) (S101).

The main server (100) receives a currency exchange request and determines the exchange rate (S102).

It verifies whether the requested amount of first national currency has been deposited into the wallet. If deposited, it records the equivalent amount in the second national currency in the wallet account and stores the exchange transaction across the blockchain network (S103).

Through this process, the main server (100) securely stores all exchange-related information using blockchain technology.

Based on the stored blockchain data, exchange transaction history, and the exchange request, the main server (100) proceeds to provide the exchange service. To do so, it receives from the user terminal (200) a reverse exchange request to convert the second national currency back into the first national currency.

Upon receiving this request, the main server (100) determines the applicable exchange rate for selling the second national currency and purchasing the first national currency. It records the transaction in the wallet and creates a second block of information by matching the currencies, amounts, exchange rate, timestamp, and user terminal identifier. This second block is then distributed and stored in the blockchain network.

The determination of the exchange rate and generation of the second block can follow the same procedures as described for the first block.

In an embodiment of the present invention, the creation and distributed storage of the first and second block records may occur without any actual deposit or withdrawal between the first and second national currency bank accounts. That is, the exchange transaction is only recorded in the wallet, representing a trusted acknowledgment of the user's exchange intent, while the actual currency exchange is performed later in a subsequent process handled by the main server (100).

According to an additional embodiment, a fee-based model may be implemented based on exchange rate graphs and predictive results. For example, the present invention can be utilized to generate revenue through simple foreign exchange, or to reduce remittance costs by identifying and using more favorable exchange rates. Although exchange rate forecasting is inherently difficult, the system can analyze exchange rate trends using a combination of exchange rate graphs, web data related to international affairs, and social media data. Based on such predictions, the system can guide users on the optimal time to remit funds.

For instance, if a user named A intends to send living expenses to their family in the United States, and the server predicts that the exchange rate will drop the next day, the server can notify the user that sending money tomorrow will result in a more favorable rate. If the prediction proves accurate, a small service fee may be added to the exchange rate (so that the applied rate+fee is still better than yesterday's rate), and the exchange can be executed accordingly. This model allows the server to generate profit.

To enable this, various types of big data can be collected—including exchange rates, news articles from the web, social media posts, commodity prices such as crude oil, and real estate prices. These data serve as inputs for designing and training an AI model to predict the next day's exchange rate. Ideally, reinforcement learning is used, where the system receives rewards when predictions are accurate. If the prediction is incorrect, the remittance may be executed at a rate more favorable than that of the originally scheduled date, minimizing user loss. As the AI model becomes more refined and accurate, the number of correct predictions is expected to surpass incorrect ones, enabling consistent revenue generation via service fees.

Actual foreign exchange transactions are carried out when the main server (100) receives a withdrawal request for the second national currency from the user terminal (200). Upon receiving this request, the main server (100) withdraws the specified amount from the associated second-national-currency bank account and transfers it to the user-designated bank account. Similarly, if a withdrawal request for the first national currency is received, the server withdraws the corresponding amount from the associated first-national-currency bank account and transfers it to the wallet-linked first-national-currency bank account.

In other words, no direct financial transactions occur between the user terminal (200) and the bank server (300). Instead, all exchanges are processed via national currency accounts operated by the main server (100).

Therefore, the main server (100), based on the previously recorded first and second block data, can provide the requested exchanged amount to the user terminal (200) immediately, independent of bank or foreign exchange intermediary business hours. Transfers to bank accounts occur only after the exchange process has been completed on the user side.

As another embodiment, a separate platform token may be issued, functioning as a tradable asset similar to cryptocurrency. Any national currency can be used to buy or sell this token, which may also serve as an intermediary for currency exchange. For example, a user could purchase the token with the first national currency and then buy the second national currency using the token.

The token may be pegged to a specific currency (e.g., the U.S. dollar), functioning similarly to a stablecoin, or it may maintain a fixed benchmark value. As such, conducting exchanges via tokens instead of direct currency-to-currency transactions can provide a hedging effect against exchange rate fluctuations.

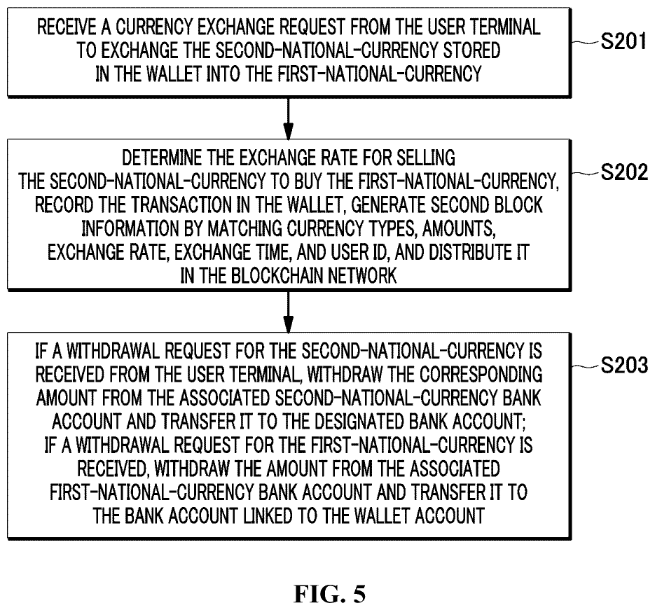

Referring to FIG. 5, the flow of the aforementioned currency exchange service will now be described again. First, the main server (100) receives a currency exchange request from the user terminal (200) to convert the second national currency stored in the wallet into the first national currency (S201).

Then, the main server determines the exchange rate for selling the second national currency and purchasing the first national currency. After recording the exchange transaction details in the wallet, the main server generates second block data by matching the currency types and amounts, exchange rate, exchange timestamp, and the user terminal's identification information. This block data is then distributed and stored on the blockchain network (S202).

Subsequently, when the user terminal (200) sends a withdrawal request for the second national currency, the main server (100) withdraws the corresponding amount from the linked second national currency bank account and transfers it to the bank account designated by the user. Likewise, when a withdrawal request for the first national currency is received, the main server (100) withdraws the requested amount from the first national currency bank account and transfers it to the wallet-linked first national currency bank account (S203).

An embodiment of the present invention may also be implemented in the form of a non-transitory computer-readable medium that includes computer-executable instructions such as program modules. A computer-readable medium may be any usable medium that can be accessed by a computer and includes both volatile and non-volatile, and removable and non-removable media. It may include computer storage media which encompasses all storage devices implemented in any method or technology to store information such as computer-readable instructions, data structures, program modules, or other data.

The methods and systems of the present invention have been described in connection with certain embodiments, but all or part of their components or operations may be implemented using a general-purpose computer system architecture.

The foregoing description is intended to be illustrative and not limiting. Those skilled in the art will understand that the scope of the present invention is not limited to the disclosed embodiments and that various modifications and variations can be made without departing from the spirit or essential characteristics of the invention.

Therefore, the embodiments described above should be considered exemplary rather than restrictive, and the scope of the invention should be interpreted based on the claims that follow, along with any equivalents derived from their meaning and scope. For example, each component described as a standalone unit may be implemented in a distributed manner, and vice versa.

What is claimed is:

1. A method for providing a 24-hour currency exchange service based on a blockchain wallet, performed by a main server, comprising:
(a) generating a wallet account linked to a first national currency bank account of a user in response to a request from a user terminal;
(b) receiving a currency exchange request from the user terminal and determining an exchange rate; and
(c) verifying whether the amount of the requested first national currency has been deposited into the wallet account, and if the deposit has been made, recording the corresponding amount of the second national currency in the wallet account and distributing and storing the exchange transaction between the first and second national currencies on a blockchain network,
wherein in step (b),
if the exchange request occurs outside of business hours when a standard exchange rate from a foreign exchange broker is not available, the exchange rate is determined according to a predefined policy set by the main server so that the exchange is executed accordingly, in a method for providing a 24-hour currency exchange service based on a blockchain wallet.

2. The method of claim 1,
wherein in step (a),
the wallet account is generated to be linked with a bank account operated by a domestic bank and an account operated by the main server, in the method for providing a 24-hour currency exchange service based on a blockchain wallet.

3. The method of claim 1,
wherein step (b) comprises:
(b-1) receiving input, from the user terminal, of the type and amount of the first national currency to be deposited into the wallet account;
(b-2) receiving input, from the user terminal, of the type of the second national currency to be received in the wallet account; and
(b-3) determining an exchange rate for purchasing the second national currency with the first national currency based on a policy of the main server and the time at which the exchange request is received, in the method for providing a 24-hour currency exchange service based on a blockchain wallet.

4. The method of claim 3,
wherein the exchange rate is set according to the standard rate provided by a foreign exchange broker, or, during non-business hours of the foreign exchange broker, is set based on the average of the day's buying and selling rates, in the method for providing a 24-hour currency exchange service based on a blockchain wallet.

5. The method of claim 1,
wherein step (c) comprises:
after recording the exchange transaction in the wallet account, generating first block information by matching the type and amount of the first national currency, the type and amount of the second national currency, the exchange rate, the time of exchange, and identification information of the user terminal, and distributing and storing the first block information on a blockchain network using a blockchain technique in at least one main server and another terminal connected to the main server, in the method for providing a 24-hour currency exchange service based on a blockchain wallet.

6. The method of claim 5,
wherein the exchange transaction record includes the exchanged amount of the second national currency, the exchange rate, and the time of exchange for each transaction, and further displays exchange gain/loss information between the amount of the second national currency at the time of exchange and the amount at a preset time before or after that exchange, in the method for providing a 24-hour currency exchange service based on a blockchain wallet.

7. The method of claim 1, further comprising:
(d) receiving, from the user terminal, a request to exchange the second national currency stored in the wallet into the first national currency; and
(e) determining an exchange rate for selling the second national currency and buying the first national currency, recording the exchange transaction in the wallet, generating second block information by matching the type and amount of the first and second national currencies, exchange rate, exchange time, and user terminal identification information, and distributing and storing the second block information on a blockchain network, in the method for providing a 24-hour currency exchange service based on a blockchain wallet.

8. The method of claim 7,
wherein steps (c) through (e) include generating and distributing first and second block information for the exchange transactions, without performing actual fund transfers between the bank accounts for the first and second national currencies, and only recording the exchange transaction in the wallet, in the method for providing a 24-hour currency exchange service based on a blockchain wallet.

9. The method of claim 1, further comprising:
(f) upon receiving a withdrawal request for the second national currency from the user terminal, withdrawing the requested amount from a second national currency bank account associated with the main server and transferring it to a bank account designated by the user terminal; and
upon receiving a withdrawal request for the first national currency from the user terminal, withdrawing the requested amount from a first national currency bank account associated with the main server and transferring it to the first national currency bank account linked with the wallet account, in the method for providing a 24-hour currency exchange service based on a blockchain wallet.

10. A server for providing a 24-hour currency exchange service based on a blockchain wallet, comprising:
a memory in which a program for performing the method for providing the 24-hour currency exchange service based on a blockchain wallet is stored; and
a processor for executing the program,
wherein the method comprises:
(a) generating a wallet account linked to a first national currency bank account of a user in response to a request from a user terminal;
(b) receiving a currency exchange request from the user terminal and determining an exchange rate; and
(c) verifying whether the amount of the requested first national currency has been deposited into the wallet account, and if deposited, recording the corresponding amount of the second national currency in the wallet account and distributing and storing the exchange transaction between the first and second national currencies on a blockchain network,
wherein in step (b), if the exchange request occurs outside of business hours when a standard exchange rate from a foreign exchange broker is not available, the exchange rate is determined according to a predefined policy set by the main server, in the server for providing a 24-hour currency exchange service based on a blockchain wallet.
